(19) United States
(12) Patent Application Publication
(10) Pub. No.: US 2003/0164001 A1
(43) Pub. Date: Sep. 4, 2003

(54) Vehicle having dual loop heating and cooling system

(76) Inventors: Franck A. Vouzelaud, Paris (FR); Thomas P. Gielda, Brighton, MI (US); Shane A. Harte, Farminton Hills, MI (US); David K. Johnson, Canton, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/091,040

(22) Filed: Mar. 4, 2002

(51) Int. Cl. B60H 3/00; B61D 27/00; B60H 1/00; B60H 1/32; F25D 17/02

(52) U.S. Cl. 62/244; 165/202; 62/434; 62/435; 165/42; 165/43

(57) ABSTRACT

A vehicle heating and cooling system having both a coolant loop with a heater core employing a coolant to warm a passenger compartment of the vehicle, and a refrigerant loop with an air conditioning system for cooling the passenger compartment of the vehicle. The refrigerant loop and coolant loop can also operate together where the air conditioning system is operating as a heat pump and drawing heat from the coolant loop.

### BACKGROUND OF INVENTION

The present invention relates to heating, ventilation and air conditioning systems for vehicles.

In a conventional automotive vehicle employing an internal combustion engine, the heating of the passenger compartment is accomplished by running engine coolant, typically a mix of water and glycol (antifreeze), through a heater core in the passenger compartment, and then blowing air over the heater core and onto the passengers. The drawback with this is that the heater core will not provide heat until the engine has caused the coolant to warm up. For most conventional engines, this time to warm up the coolant is sufficiently short to satisfy the vehicle passengers.

Now, however, newer engines and powertrain arrangements are being developed where the engine does not produce as much excess heat for the coolant to absorb. Some examples are a direct injection engine and a hybrid (engine/motor) powertrain. For these types of powertrains, the temperature of the coolant can take a very long time to rise to a level where it will allow for adequate heating of the passenger compartment when using a conventional system.

Most automotive vehicles today also include an air conditioning system for cooling the air in the passenger compartment. The air conditioning system can begin to operate as soon as the vehicle is started. Consequently, some have recognized that the components of the air conditioning system can be employed to operate in a heat pump mode, and so the conventional coolant based heating system is replace with heat from the heat pump operation. But these systems become less and less efficient for heating as the ambient air temperature becomes colder. Consequently, they have not proven efficient enough to provide an adequate heating function to replace the current type of heating system.

Thus, it is desirable to have a vehicle heating and cooling system that overcomes the drawbacks of conventional vehicle heating, and heat pump systems in order to warm a vehicle passenger compartment more quickly.

### SUMMARY OF INVENTION

In its embodiments, the present invention contemplates a heating and cooling system for a vehicle having an engine. The heating and cooling system includes a coolant loop having a coolant outlet line and a coolant inlet line adapted to couple to the engine, a heater core, a coolant/refrigerant heat exchanger, and a coolant valve for selectively directing flow of a coolant from the coolant outlet line to the coolant inlet line through one of the heater core and the coolant/refrigerant heat exchanger. The heating and cooling system also includes a refrigerant loop having a compressor with an inlet and an outlet, a condenser, an air/refrigerant heat exchanger, a first refrigerant valve for selectively directing flow of a refrigerant from the compressor outlet to one of the condenser and the air/refrigerant heat exchanger, a second refrigerant valve for selectively directing flow of the refrigerant between the air/refrigerant heat exchanger and one of the coolant/refrigerant heat exchanger and the condenser, and a third refrigerant valve for selectively preventing flow of the refrigerant from the air/refrigerant heat exchanger directly to the compressor inlet.

The present invention further contemplates a method of providing heating and cooling to a passenger compartment of a vehicle having an engine, the method comprising the steps of: selectively circulating a coolant from the engine, through one of a heater core located in the passenger compartment and a coolant/refrigerant heat exchanger, and back to the engine; and selectively circulating a refrigerant from a compressor and back to the compressor through one of a first refrigerant path, having a condenser, an air/refrigerant heat exchanger located in the passenger compartment, and an expansion valve between the condenser and the air/refrigerant heat exchanger, and a second refrigerant path, having the air/refrigerant heat exchanger, the coolant/refrigerant heat exchanger, and the expansion valve between the air/refrigerant heat exchanger and the coolant/refrigerant heat exchanger.

The present invention also contemplates a method of heating and cooling a passenger compartment of a vehicle having an engine, the method comprising the steps of: heating the passenger compartment by compressing a refrigerant, passing the refrigerant through a first air/refrigerant heat exchanger in the passenger compartment, forcing air through the first air/refrigerant heat exchanger, passing the refrigerant through an expansion valve, passing the refrigerant through a coolant/refrigerant heat exchanger, and passing a coolant from the engine through the coolant/refrigerant heat exchanger; and cooling the passenger compartment by compressing the refrigerant, passing the refrigerant through a condenser outside of the passenger compartment, passing the refrigerant through the first expansion valve, passing the refrigerant through the air/refrigerant heat exchanger in the passenger compartment, and forcing air through the air/refrigerant heat exchanger.

An embodiment of the present invention has a vehicle heating and cooling system that allows for conventional heater core heating in one mode of operation, a conventional air conditioning system operation for a cooling mode of operation, and a heating mode employing the air conditioning system as a heat pump with refrigerant that absorbs heat from the engine coolant.

An advantage of the present invention is that the vehicle heating and cooling system can operate in a conventional air conditioning mode, with cooling efficiencies essentially as good as with a conventional air conditioning system, and yet still operate in a heat pump mode to provide supplemental heating when the conventional heating system is not up to an efficient operating temperature.

Another advantage of the present invention is that, in the heat pump mode of operation, the refrigerant in the heat pump system absorbs heat from the engine coolant, which is more efficient than absorbing heat from the ambient air.

A further advantage of the present invention is that the heating and cooling system can operate in all three modes with a minimum of heat exchangers, valves and other system components, thus minimizing the cost of the system.

### BRIEF DESCRIPTION OF DRAWINGS

FIG. 1 is a schematic diagram of a portion of a heating and cooling system that is located in a passenger compartment of a vehicle, in accordance with the present invention;

FIG. 2 is a schematic diagram of the vehicle heating and cooling system, illustrating the direction of fluid flow during a cooling cycle, in accordance with the present invention;

FIG. 3 is a schematic diagram similar to FIG. 2, but illustrating a heat pump cycle;

FIG. 4 is a schematic diagram of a second embodiment of the heating and cooling system; and

FIG. 5 is a schematic diagram of a third embodiment of the heating and cooling system.

### DETAILED DESCRIPTION

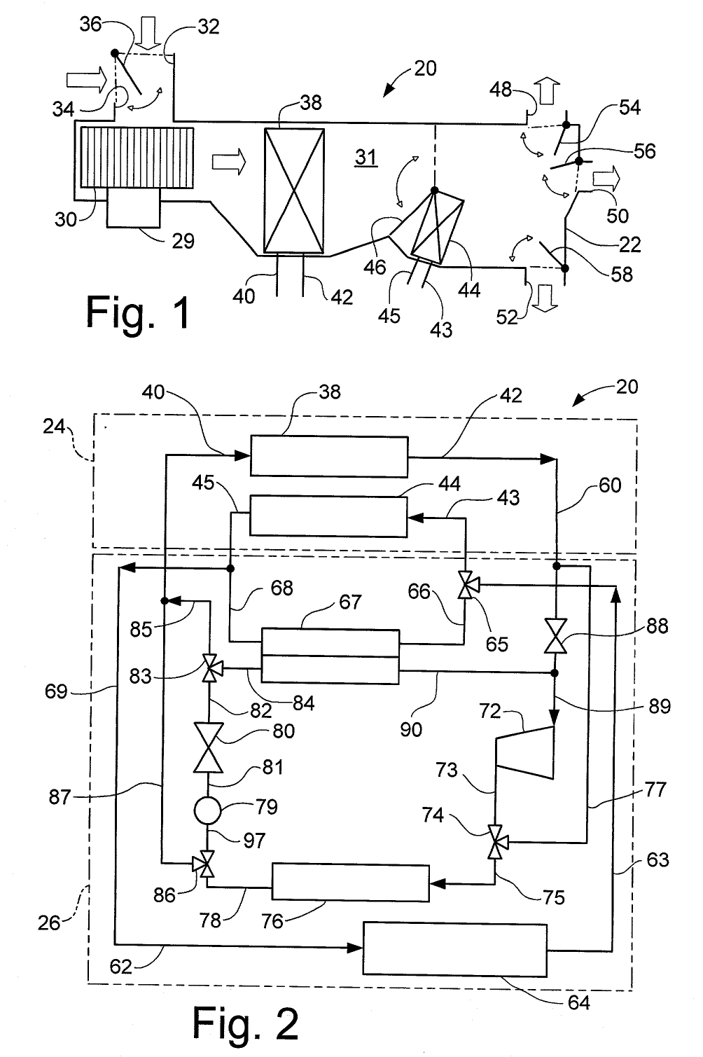

FIGS. 1-3 illustrate a vehicle heating and cooling system 20 that is partially located behind an instrument panel 22 in a vehicle passenger compartment 24, and partially in a vehicle engine compartment 26. The system 20 includes a blower 30, driven by a motor 29, and mounted in an air passage 31 in the passenger compartment 24. The blower 30 is located adjacent to an external air inlet 32, an internal air inlet 34, and an air mixing damper 36 that can be moved to partially or fully block off the external air inlet 32 or the internal air inlet 34 from the air passage 31.

Also located in the air passage 31, near the blower 30, is a first air/refrigerant heat exchanger 38. This heat exchanger 38 includes a pair of refrigerant lines 40 and 42 for directing refrigerant into and out of the heat exchanger 38. The refrigerant in the lines 40, 42 may be any type of refrigerant found in air conditioning or refrigeration systems, such as, for example, R134a. A heater core 44 is located in the air passage 31, as well as a second air mixing damper 46, which can be moved to allow air flow through the heater core 44, block air flow from the heater core 44, or allow for a partial flow. An engine coolant intake line 43 and an engine coolant outlet line 45 connect to the heater core 44. The engine coolant in these lines 43, 45 may be any type of coolant found in engine cooling systems, such as, for example, a mixture of water and glycol. The heater core 44, then, is an air/coolant heat exchanger.

The air passage 31 also includes three air outlets 48, 50 and 52, with three corresponding dampers 54, 56 and 58 that can be adjusted to vary the flow through each of the air outlets 48, 50, 52. These air outlets may be, for example, an outlet 48 directed toward a vehicle windshield (not shown) for defrosting, an outlet 50 directed toward the bodies of vehicle occupants (not shown), and an outlet 52 directed toward the feet of vehicle occupants.

The heating and cooling system 20 includes two main loops—there is a refrigerant loop 60 and a coolant loop 62. The coolant loop 62 includes an outlet line 63 coming from an engine 64 and leading to a coolant three-way valve 65. The three-way valve 65 also connects to the coolant intake line 43 to the heater core 44, and to an intake line 66 to coolant passages in a coolant/refrigerant heat exchanger 67. The coolant outlet line 45 from the heater core 44 and a coolant outlet line 68 from the heat exchanger 67 join into a coolant inlet line 69 running back to the engine 64. The coolant is pumped through the coolant loop 62 with a conventional water pump (not shown), which is part of a conventional engine cooling system (not shown) including a radiator, fan, etc.

The refrigerant loop 60 includes a compressor 72. The compressor 72 may be any one of several different types (for example, piston, swash plate, scroll), it may be driven by the engine 64 or by a separate motor, and it may have a clutch to disconnect it from the engine or motor or it may be a variable capacity type, as may be desired depending upon the particular vehicle and refrigerant loop. The compressor 72 connects to a compressor outlet line 73 which leads to a first refrigerant three-way valve 74. The three-way valve 74 also connects to a condenser inlet line 75 that leads to a condenser 76, and to a refrigerant line 77 that leads to the first heat exchanger line 42. A condenser outlet line 78 connects to second three-way valve 86, which, in turn, connects to a receiver/drier 79 via refrigerant line 97. The receiver/drier 79 connects to an expansion valve 80 via an expansion valve inlet line 81. An expansion valve outlet line 82 leads to a third refrigerant three-way valve 83. This three-way valve 83 also connects to the refrigerant passages in the coolant/refrigerant heat exchanger 67, via a refrigerant inlet line 84, and to the first air/refrigerant heat exchanger line 40, via a refrigerant line 85. The heat exchanger refrigerant line 40 leads to a the second three-way valve 86 via refrigerant line 87. The heat exchanger refrigerant line 42 leads to an on/off valve 88, which in turn leads to the compressor 72 via a compressor intake line 89. A refrigerant line 90 also extends between the refrigerant passages of the coolant/refrigerant heat exchanger 67 and the compressor intake line 89.

The operation of the first embodiment, illustrated in FIGS. 1-3, will now be discussed. There are three different modes of operation for the heating and cooling system 20. The first mode is the cooling (air conditioning) mode. The flow of the refrigerant and the coolant for this mode are illustrated in FIG. 2.

The refrigerant is compressed by the compressor 72 and flows into the first refrigerant three-way valve 74, which directs it into the condenser 76 via condenser inlet line 75. The three-way valve 74 is closed to line 77. The action of the compressor 72 in compressing the refrigerant causes the refrigerant temperature to rise. Ambient air flowing through the condenser 76 will absorb heat from the refrigerant. The refrigerant will then flow through the condenser outlet line 78 and through the three-way valve 86 to the receiver/drier 79. The three-way valve 86 is closed to line 87. The receiver/drier 79 will remove moisture from the refrigerant and assures one hundred percent liquid to the expansion valve. The refrigerant then flows, via inlet line 81, into the expansion valve 80. The expansion valve 80 will regulate the pressure of the refrigerant, and thus, the temperature of the refrigerant leaving the expansion valve 80. This refrigerant will pass though the outlet line 82, to the third refrigerant three-way valve 83, through the refrigerant line 85, through line 40, and into the first air/refrigerant heat exchanger 38. The third three-way valve 83 will be closed to line 84. The blower 30 forces air across the heat exchanger 38, which will absorb heat from the air before the air flows into the passenger compartment 24. Thus, the heat exchanger 38 will act as an evaporator and absorb heat from the air flowing through it. The refrigerant will flow out of the heat exchanger 38, through the open one-way valve 88, via refrigerant line 42, and back to the compressor 72, via line 89. So in the cooling mode, the system 20 operates essentially the same as with a conventional vehicle air conditioning system.

In the first mode of operation, the engine coolant flows from the engine 64, through the outlet line 63, through the coolant three-way valve 65, through coolant intake line 43 and into the heater core 44. The coolant three-way valve 65 is closed to line 66. While the blower 30 will create air flow within the air passage 31, the damper 46 is closed and so the air entering the passenger compartment 24 will not pass over the heater core 44. Thus, the coolant will have only a vary negligible effect on the temperature of the air flowing into the passenger compartment 24. From the heater core 44, the coolant flows through coolant outlet line 45, through coolant engine inlet line 69, and back to the engine. The coolant flow within the engine 64 and radiator (not shown) will not be discussed since it is conventional.

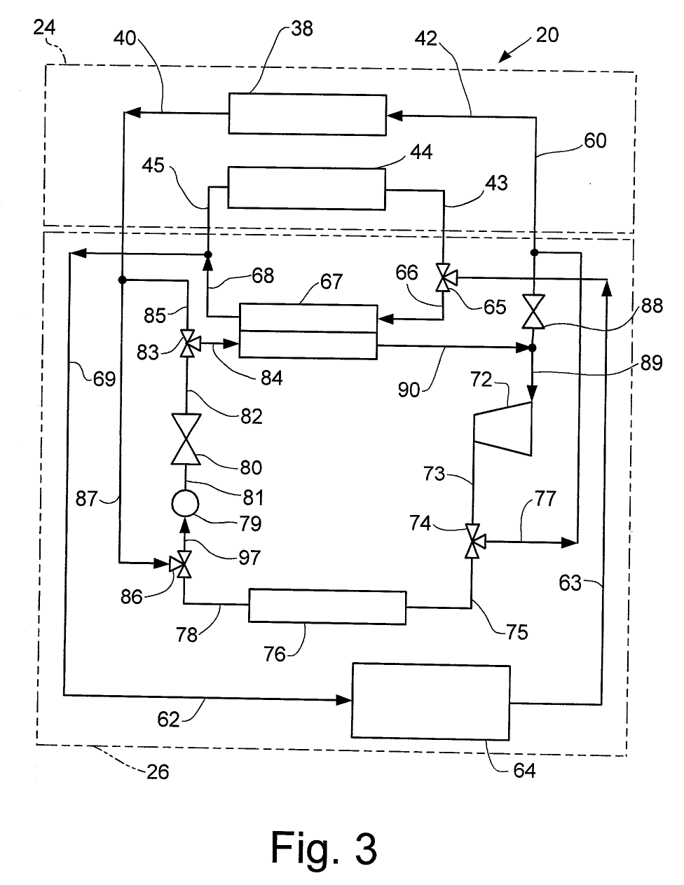

The second mode of operation is the heat pump mode. The direction of flow of refrigerant and coolant for this mode is illustrated in FIG. 3. This mode is employed when the engine and coolant is still cool, but the passenger compartment 24 needs to be warmed. In this mode, the refrigerant flows through the compressor 72, where it is compressed, and to three-way valve 74 via compressor outlet line 73. The three-way valve 74 directs the refrigerant into refrigerant line 77, and blocks the flow into condenser inlet line 75. The compressed refrigerant then flows into the heat exchanger line 42, and into the first air/refrigerant heat exchanger 38. It does not flow into compressor intake line 89 because the on/off valve 88 is closed.

The blower 30 forces air through the heat exchanger 38, warming the air before it flows into the passenger compartment 24. So in this heat pump mode, the heat exchanger 38 acts as a condenser. The refrigerant then flows through heat exchanger line 40, through the line 87, through three-way valve 86, through line 97, through the receiver/drier 79, and then through the expansion valve 80 via line 81. The expansion valve 80 controls the flow (and hence the pressure) of the refrigerant as it flows through the expansion valve outlet line 82, through the third three-way valve 83, through refrigerant line 84 (blocking the flow into the refrigerant line 85), and into the refrigerant lines of the coolant/refrigerant heat exchanger 67. At the lower pressure and with some of the heat removed from the refrigerant by the heat exchanger 38, the refrigerant will be at a lower temperature than the coolant in the heat exchanger 67. Thus, the refrigerant will absorb some heat from the coolant, so the heat exchanger 67 acts as an evaporator in the refrigerant loop. The refrigerant then flows into the refrigerant line 90, and through the compressor intake line 89 back to the compressor 72.

In the heat pump mode of operation, the coolant flows from the engine 64, through the coolant outlet line 62 and into the coolant three-way valve 65. The three-way valve 65 directs the flow of coolant into heat exchanger intake line 66, but blocks it from flowing into coolant intake line 43. As mentioned above, as the coolant flows through the coolant/refrigerant heat exchanger 67, the heat exchanger 67 pulls heat from the coolant and delivers it to the refrigerant. Using the engine coolant as the heat source for the refrigerant is much more practical than using ambient air as the heat source, thus increasing the heat output in the heat pump mode of operation. The coolant then recirculates back to the engine 64, via the lines 68 and 69, where it will absorb heat from the operating engine 64.

The third mode of operation is a conventional heating mode. This mode occurs when the coolant is hot and it is desired to add heat to the passenger compartment 24. In this mode, the compressor 72 is not operating, so the refrigerant is not flowing. The coolant flows through the coolant loop 62 the same as in the cooling mode, as discussed above. But the damper 46 is now open, so air flowing through the passage 31 will pass through the heater core 44 and be warmed before it enters the passenger compartment.

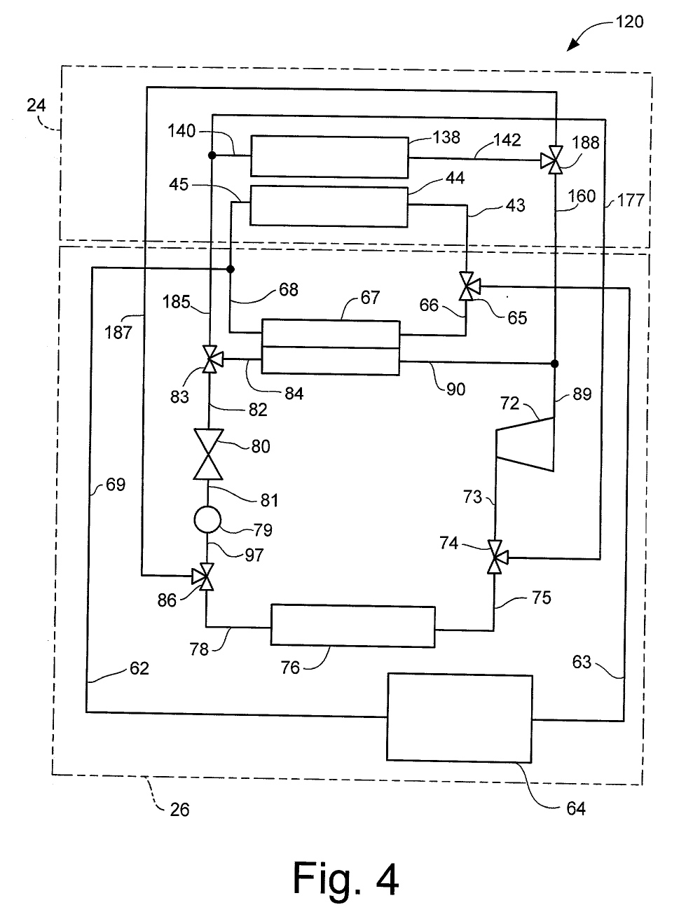

FIG. 4 illustrates a second embodiment of the present invention. In this embodiment, elements that are the same as in the first embodiment will be designated with the same element numbers, while those that have changed or have been added will be designated with 100 series numbers. The major components are located in the same compartments of the vehicle, whether it is the passenger compartment 24 or the engine compartment 26. The coolant loop 62, including the engine 64, coolant lines 43, 45, 63, 66, 68, 69, coolant three-way valve 65, heater core 44, and coolant/refrigerant heat exchanger 67 are essentially the same as in the first embodiment.

The refrigerant loop 160 is similar to the first embodiment, but has been modified so that the refrigerant flows through the heat exchanger 138 in the same direction for both the cooling mode and the heat pump mode. The Compressor 72, first three-way valve 74, condenser 76, second three-way valve 86, receiver/drier 79, expansion valve 80, third three-way valve 83, coolant/refrigerant heat exchanger 67, and the refrigerant lines 73, 75, 78, 81, 82, 84, 89, 90, and 97 are the same as in the first embodiment.

The refrigerant on/off valve has been eliminated. Further, the refrigerant loop 160 now includes a fourth refrigerant three-way valve 188, which selectively connects the heat exchanger refrigerant line 142 with refrigerant line 160 (leading to the compressor) or the refrigerant line 187 (leading to the condenser outlet line 78). Also, the heat exchanger refrigerant line 140 now connects to refrigerant line 185 (which leads to the three-way valve 83) and to refrigerant line 177 (which leads to the three-way valve 74).

The second embodiment of the heating and cooling system 120 operates in the same three modes (cooling, heat pump, and conventional heating) as in the first embodiment. The main elements of the system all work the same as in the first embodiment, with the exception of the heat exchanger 138, which now has flow in the same direction for both the first and second modes of operation, rather than reversing the flow direction of the refrigerant as in the first embodiment. But, the heat exchanger 138 still operates as an evaporator in the cooling mode of operation and as a condenser in the heat pump mode of operation, the same as with the first embodiment. Therefore, the operation of the heating and cooling system 120 of the second embodiment will not be discussed in any more detail.

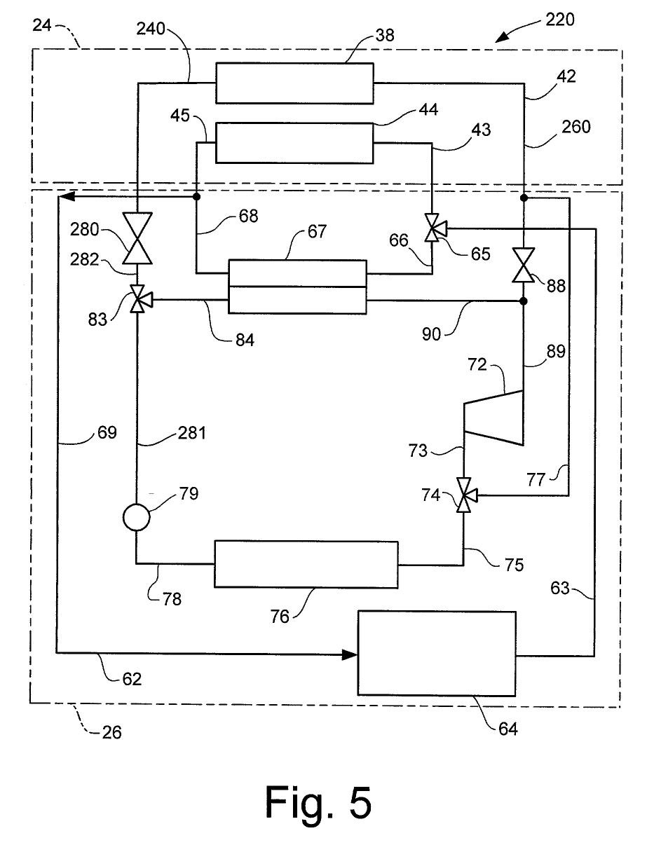

FIG. 5 illustrates a third embodiment of the present invention. In this embodiment, elements that are the same as in the first embodiment will be designated with the same element numbers, while those that have changed or have been added will be designated with 200 series numbers. The major components are located in the same compartments of the vehicle, whether it is the passenger compartment 24 or the engine compartment 26. The coolant loop 62, including the engine 64, coolant lines 43, 45, 63, 66, 68, 69, coolant three-way valve 65, heater core 44, and coolant/refrigerant heat exchanger 67 are essentially the same as in the first embodiment.

The refrigerant loop 260 is similar to the first embodiment, but has been modified so that there is one less refrigerant valve and a reduced set of refrigerant lines. The Compressor 72, first three-way valve 74, condenser 76, receiver/drier 79, third three-way valve 83, coolant/refrigerant heat exchanger 67, air/refrigerant heat exchanger 38, on/off valve 88, and the refrigerant lines 42, 73, 75, 77, 78, 84, 89, and 90 are the same as in the first embodiment. The second three-way valve and some refrigerant lines have been eliminated. Further, the expansion valve 280 is now configured to operate in both directions of refrigerant flow. The refrigerant loop 260 now includes a refrigerant line 281, which directly connects the receiver/drier 79 to the second three-way valve 83—but the receiver/drier 79 is only operative when the system 220 is in the cooling mode. The expansion valve 280 now connects to refrigerant lines 282 (leading to the third three-way valve 83) and refrigerant line 240 (leading to the air/refrigerant heat exchanger 38).

The third embodiment of the heating and cooling system 220 operates in the same three modes (cooling, heat pump, and conventional heating) as in the first embodiment. The main elements of the system all work the same as in the first embodiment, with the exception of the expansion valve 280 and the receiver/drier 79, as discussed above. Therefore, the operation of the heating and cooling system 220 of the third embodiment will not be discussed in any more detail.

As an alternative to having the expansion valve 280 operate in both directions, it may be replaced with an orifice tube (not shown) at the same location, in which case, the receiver/drier 79 would be eliminated and an accumulator (not shown) would be added in the compressor intake line 89.

While certain embodiments of the present invention have been described in detail, those familiar with the art to which this invention relates will recognize various alternative designs and embodiments for practicing the invention as defined by the following claims.

What is claimed is:

1. A heating and cooling system for a vehicle having an engine, the heating and cooling system comprising:
a coolant loop having a coolant outlet line and a coolant inlet line adapted to couple to the engine, a heater core, a coolant/refrigerant heat exchanger, and a coolant valve for selectively directing flow of a coolant from the coolant outlet line to the coolant inlet line through one of the heater core and the coolant/refrigerant heat exchanger; and
a refrigerant loop having a compressor with an inlet and an outlet, a condenser, an air/refrigerant heat exchanger, a first refrigerant valve for selectively directing flow of a refrigerant from the compressor outlet to one of the condenser and the air/refrigerant heat exchanger, a second refrigerant valve for selectively directing flow of the refrigerant between the air/refrigerant heat exchanger and one of the coolant/refrigerant heat exchanger and the condenser, and a third refrigerant valve for selectively preventing flow of the refrigerant from the air/refrigerant heat exchanger directly to the compressor inlet.

2. The system of claim 1 further including an expansion valve for controlling flow of the refrigerant between the condenser and the air/refrigerant heat exchanger.

3. The system of claim 2 further including a receiver/drier coupled in the refrigerant loop between the condenser and the expansion valve.

4. The system of claim 1 further including an expansion valve for controlling flow of the refrigerant between the air/refrigerant heat exchanger and the coolant/refrigerant heat exchanger.

5. The system of claim 4 further including a receiver/drier coupled in the refrigerant loop between the condenser and the expansion valve.

6. The system of claim 1 wherein the third refrigerant valve is an on/off valve.

7. The system of claim 1 wherein the third refrigerant valve is a three-way valve.

8. The system of claim 1 wherein the vehicle includes a passenger compartment, and the air/refrigerant heat exchanger is adapted to be located within the passenger compartment.

9. The system of claim 8 wherein the vehicle includes a passenger compartment, and the heater core is adapted to be located within the passenger compartment.

10. The system of claim 1 wherein the vehicle includes a passenger compartment, and the heater core is adapted to be located within the passenger compartment.

11. The system of claim 1 wherein the first refrigerant valve is a three-way valve.

12. The system of claim 1 wherein the second refrigerant valve is a three-way valve.

13. A method of providing heating and cooling to a passenger compartment of a vehicle having an engine, the method comprising the steps of:
selectively circulating a coolant from the engine, through one of a heater core located in the passenger compartment and a coolant/refrigerant heat exchanger, and back to the engine; and
selectively circulating a refrigerant from a compressor and back to the compressor through one of a first refrigerant path, having a condenser, an air/refrigerant heat exchanger located in the passenger compartment, and an expansion valve between the condenser and the air/refrigerant heat exchanger, and a second refrigerant path, having the air/refrigerant heat exchanger, the coolant/refrigerant heat exchanger, and the expansion valve between the air/refrigerant heat exchanger and the coolant/refrigerant heat exchanger.

14. The method of claim 13 wherein the coolant is circulating through the heater core, and the refrigerant is circulating through the first refrigerant path.

15. The method of claim 13 wherein the coolant is circulating through the coolant/refrigerant heat exchanger, and the refrigerant is circulating through the second refrigerant path.

16. The method of claim 13 wherein the coolant is circulating through the heater core, and the method further includes the step of ceasing the circulation of the refrigerant.

17. The method of claim 13 further including the step of circulating the refrigerant through a receiver/drier prior to circulating the refrigerant through the expansion valve.

18. A method of heating and cooling a passenger compartment of a vehicle having an engine, the method comprising the steps of:
heating the passenger compartment by compressing a refrigerant, passing the refrigerant through a first air/refrigerant heat exchanger in the passenger compartment, forcing air through the first air/refrigerant heat exchanger, passing the refrigerant through an expansion valve, passing the refrigerant through a coolant/refrigerant heat exchanger, and passing a coolant from the engine through the coolant/refrigerant heat exchanger; and
cooling the passenger compartment by compressing the refrigerant, passing the refrigerant through a condenser outside of the passenger compartment, passing the refrigerant through the first expansion valve, passing the refrigerant through the air/refrigerant heat exchanger in the passenger compartment, and forcing air through the air/refrigerant heat exchanger.

19. The method of claim 18 further including the steps of:
ceasing the compressing of the refrigerant;
ceasing passing the coolant from the engine through the coolant/refrigerant heat exchanger; and
passing the coolant through a heater core in the passenger compartment.

20. The method of claim 18 further including the step of passing the refrigerant through a receiver/drier prior to passing the refrigerant through the first expansion valve.
